(19) United States
(12) Patent Application Publication
(10) Pub. No.: US 2026/0117589 A1
(43) Pub. Date: Apr. 30, 2026

(54) CELLULAR SLATS FOR A COVERING FOR AN ARCHITECTURAL STRUCTURE WITH IMPROVED LIGHT CONTROL AND RELATED COVERINGS

(71) Applicant: Hunter Douglas Inc., New York, NY (US)

(72) Inventor: Wendell B. Colson, Vineyard Haven, MA (US)

(21) Appl. No.: 19/116,744

(22) PCT Filed: Sep. 18, 2023
(86) PCT No.: PCT/US2023/033035

§ 371 Date: Mar. 28, 2025

Related U.S. Application Data
(60) Provisional application No. 63/411,773, filed on Sep. 30, 2022.

(51) Int. Cl. E06B 9/386; E06B 9/24

(52) U.S. Cl. CPC E06B 9/386; E06B 2009/2405; E06B 2009/2488

(57) ABSTRACT

In one aspect, a cellular slat for a covering for an architectural structure includes a slat core forming a cellular structure having opposed first and second sides extending between opposed first and second edges of the slat core. Additionally, the cellular slat includes a blackout layer provided in association with only one of the first side or the second side of the cellular structure of the slat core.

### CROSS-REFERENCE TO RELATED APPLICATIONS

The present application is based upon and claims the right of priority to U.S. Provisional Patent Application No. 63/411,773, filed Sep. 30, 2022, the disclosure of which is hereby incorporated by reference herein in its entirety for all purposes.

### FIELD

The present subject matter relates generally to coverings for architectural structures and, more particularly, to cellular slats configured for use with light-control coverings for architectural structures.

### BACKGROUND

It is known within the industry to utilize cellular slats or vanes as covering elements within a covering for an architectural structure. For instance, conventional cellular slats have been formed in the past as a two-piece construction including an exterior shell or tube and an interior element positioned within the exterior tube. As an example, U.S. Pat. No. 6,688,373, entitled “Architectural Covering for Windows” and referred to hereinafter as the '373 patent, discloses an opaque slat for use with a blind that includes an exterior torque tube and a resilient insert strip that is inserted into the torque tube. While the insert strip of the '373 patent provides some structural integrity to the exterior torque tube, the disclosed “V,” “C”, and “S” folded configurations of the insert strip fail to generally provide adequate stiffness at both outer edges or joints of the slat. In addition, the resulting slat has an asymmetrical shape, which can often be aesthetically undesirable to consumers.

As an alternative to the use of separate insert strips as the interior element of a cellular slat, other known cellular slat configurations rely upon fully laminating the interior element to the exterior shell or tube. For example, it is known to laminate a film material to a fabric material and subsequently form such laminated fabric/film assembly into a closed-perimeter cell such that the fabric material is positioned along the exterior of the cell and the film material is positioned along the interior of the cell. With such configurations, the fully laminated fabric/film assembly is often folded or creased to form the opposed edges of the slat, with the free ends of the laminated fabric/film assembly being connected together to form the closed-perimeter cell. However, slats formed from such laminated fabric/film assemblies typically experience significant deformation, warping, and/or other thermal or stress-related issues when exposed to the high-end of the temperature range generally found in window environments.

Recently, an improved cellular slat configuration has been disclosed in WO 2022/086834, filed on Oct. 18, 2021 and assigned to Hunter Douglas Inc. (the disclosure of which is hereby incorporated by reference in its entirety for all purposes). While the cellular slat configuration disclosed in WO 2022/086834 has numerous advantages and addresses many of the various issues associated with previously known cellular slats, refinements and/or advancements would be welcomed to further improve upon the disclosed configuration. For instance, further refinements and/or advancements in relation to the light control provided by a cellular slat configuration would be welcomed in the technology.

### BRIEF SUMMARY

Aspects and advantages of the present subject matter will be set forth in part in the following description, or may be obvious from the description, or may be learned through practice of the present subject matter.

In one aspect, the present subject matter is directed to a cellular slat for a covering for an architectural structure. The cellular slat includes a slat core forming a cellular structure having opposed first and second sides extending between opposed first and second edges of the slat core. The cellular slat also includes a blackout layer provided in association with only one of the first side or the second side of the cellular structure of the slat core.

In another aspect, the present subject matter is directed to a cellular slat for a covering for an architectural structure. The cellular slat includes an outer sock forming an outer cellular structure, with the outer cellular structure defining a front edge and a rear edge of the cellular slat. The cellular slat also includes an inner core positioned within the outer cellular structure of the outer sock, with the inner core forming an inner cellular structure having opposed first and second sides extending between opposed first and second edges of the inner core. Additionally, the cellular slat includes a blackout layer provided in association with only one of the first side or the second side of the inner cellular structure of the inner core.

In a further aspect, the present subject matter is directed to a covering for an architectural structure. The covering includes a headrail, a bottom rail supported relative to the headrail, and a plurality of cellular slats positioned between the headrail and the bottom rail. Each cellular slat defines a front edge positioned along a front side of the covering and a rear edge positioned along a rear side of the covering. Additionally, each cellular slat includes a slat core forming a cellular structure having opposed first and second sides extending between opposed first and second edges of the slat core. Each cellular slat also includes a blackout layer provided in association with only one of the first side or the second side of the cellular structure of the slat core. The blackout layer extends only partially across the one of the first side or the second side of the cellular structure such that a light-transmissible slot is defined between the blackout layer and one of the front edge or the rear edge of the cellular slat. Moreover, the light-transmissible slot defines a slot distance between the blackout layer and the one of the front edge or the read edge of the cellular slat, and the slot distance is less than an overlap distance defined between adjacent cellular slats of the plurality of cellular slats when the plurality of cellular slats are moved to a closed position.

In yet another aspect, the present subject matter is directed to a covering for an architectural structure. The covering includes a headrail, a bottom rail supported relative to the headrail, and a plurality of cellular slats positioned between the headrail and the bottom rail. Each cellular slat defines a front edge positioned along a front side of the covering and s rear edge positioned along a rear side of the covering. Each cellular slat includes a slat core forming a cellular structure having opposed first and second sides extending between opposed first and second edges of the inner core. Additionally, each cellular slat includes a blackout layer provided in association with only one of the first side or the second side of the cellular structure of the slat core.

In another aspect, the present subject matter is directed to a covering for an architectural structure. The covering includes a headrail, a bottom rail supported relative to the headrail, and a plurality of cellular slats positioned between the headrail and the bottom rail. Each cellular slat includes an outer sock forming an outer cellular structure. The outer cellular structure defines a front edge and a rear edge of the cellular slat, with the front edge of the cellular slat being positioned along a front side of the covering and the rear edge of the cellular slat being positioned along a rear side of the covering. Each cellular slat also includes an inner core positioned within the outer cellular structure of the outer sock, with the inner core forming an inner cellular structure having opposed first and second sides extending between opposed first and second edges of the inner core. Additionally, each cellular slat includes a blackout layer provided in association with only one of the first side or the second side of the inner cellular structure of the inner core.

These and other features, aspects, and advantages of the present subject matter will become better understood with reference to the following Detailed Description and appended claims. The accompanying drawings, which are incorporated in and constitute a part of this specification, illustrate embodiments of the present subject matter and, together with the description, serve to explain the principles of the present subject matter.

This Brief Description is provided to introduce a selection of concepts in a simplified form that are further described below in the Detailed Description. This Brief Description is not intended to identify key features or essential features of the claimed subject matter, nor is it intended as an aid in determining the scope of the claimed subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates a perspective view of one embodiment of a covering for an architectural structure in accordance with aspects of the present subject matter, particularly illustrating the covering including a plurality of cellular slats;

FIG. 2 illustrates a perspective view of one embodiment of a cellular slat in accordance with aspects of the present subject matter;

FIG. 3 illustrates a cross-sectional view of the cellular slat shown in FIG. 2 taken about line 3-3, particularly illustrating one embodiment of a configuration for an outer sock, an inner core, and a blackout layer of the cellular slat in accordance with aspects of the present subject matter;

FIG. 4 illustrates an end view of the inner core of the cellular slat shown in FIG. 3 in a non-constrained, disassembled state, particularly illustrating the blackout layer positioned relative to the inner core;

FIG. 5 illustrates a similar cross-sectional view of the cellular slat shown in FIG. 3, particularly illustrating an alternative installation location for the blackout layer of the cellular slat in accordance with aspects of the present subject matter;

FIG. 6 illustrates another similar cross-sectional view of the cellular slat shown in FIG. 3, particularly illustrating another alternative installation location for the blackout layer of the cellular slat in accordance with aspects of the present subject matter;

FIG. 7 illustrates yet another similar cross-sectional view of the cellular slat shown in FIG. 3, particularly illustrating yet another alternative installation location for the blackout layer of the cellular slat in accordance with aspects of the present subject matter;

FIG. 8 illustrates a partial, side view of the covering shown in FIG. 1 with cellular slats having the configuration shown in FIGS. 2-4 installed relative thereto and being tilted to a closed-down position in accordance with aspects of the present subject matter;

FIG. 9 illustrates the same partial, side view shown in FIG. 8 with the slats tilted to a closed-up position in accordance with aspects of the present subject matter;

FIG. 10 illustrates the same cross-sectional view of the outer sock and inner core of the cellular slat shown in FIG. 3 with an embodiment of a blackout layer providing a slotted blackout arrangement installed relative thereto in accordance with aspects of the present subject matter;

FIG. 11 illustrates an end view of the inner core of the cellular slat shown in FIG. 10 in a non-constrained, disassembled state, particularly illustrating the blackout layer positioned relative to the inner core;

FIG. 12 illustrates the same cross-sectional view of the outer sock and inner core of the cellular slat shown in FIG. 3 with another embodiment of a blackout layer providing a slotted blackout arrangement installed relative thereto in accordance with aspects of the present subject matter;

FIG. 13 illustrates an end view of the inner core of the cellular slat shown in FIG. 12 in a non-constrained, disassembled state, particularly illustrating the blackout layer positioned relative to the inner core;

FIG. 14 illustrates a partial, side view of the covering shown in FIG. 1 with cellular slats having the configuration shown in FIGS. 10 and 11 installed relative thereto and being tilted to a closed-down position in accordance with aspects of the present subject matter;

FIG. 15 illustrates the same partial, side view shown in FIG. 14 with the slats tilted to a closed-up position in accordance with aspects of the present subject matter;

FIG. 16 illustrates an alternative cross-sectional view of the cellular slat shown in FIG. 2 taken about line 3-3, particularly illustrating one embodiment of a sockless cellular slat including aa slat core and a blackout layer in accordance with aspects of the present subject matter; and

FIG. 17 illustrates an alternative cross-sectional view of the cellular slat shown in FIG. 12, particularly illustrating one embodiment of a sockless cellular slat including a slat core and a blackout layer in accordance with aspects of the present subject matter.

### DETAILED DESCRIPTION

In general, the present subject matter is directed to a cellular slat configured for use within a covering for an architectural feature or structure (referred to herein simply as an architectural “structure” for the sake of convenience and without intent to limit). As will be described below, the cellular slat generally includes a slat core forming a cellular structure of the slat. Additionally, in accordance with aspects of the present subject matter, the cellular slat includes a one-sided blackout arrangement. Specifically, in several embodiments, a blackout layer may be provided along only one side of the cellular slat.

As will be described below, the one-sided blackout arrangement may allow the disclosed cellular slats to provide different lighting effects or different degrees of light control for an associated covering depending on whether the slats are moved to a first closed position (e.g., closed-down position) or a second closed position (e.g., a closed-up position). For instance, when the slats are tilted to one of the closed positions such that the blackout layers of the slats are all positioned along a rear side of the covering, any light transmitted from the rear side of the covering at the slat-to-slat interface is allowed to pass into the interior of the cells, at which point the light is diffused across the interior of each cell. As a result of such light diffusion through, the slats will have a soft glow or soft lighting effect along the front side of the covering that provides a generally aesthetically pleasing look to the covering and also serves to hide or render virtually unnoticeable any imperfections provided at the slat-to-slat interfaces. Additionally, when the slats are tilted to the other closed position such that the blackout layers of the slats are all positioned along the front side of the covering, the slats will have a much darker appearance across the front side of the covering with soft reveal lines being provided at the slat-to-slat interfaces. Specifically, the blackout layers will generally block light from passing through the slats along the front side of the covering. However, due to the one-sided blackout arrangement, a small amount of diffuse light will be allowed to pass through the covering at the slat-to-slat interfaces to provide a very soft, uniform reveal line between each adjacent pair of slats that hides or renders virtually unnoticeable any imperfections defined at the slat-to-interfaces.

As indicated above, the cellular slat generally includes a slat core forming a cellular structure of the slat. In one embodiment, the slat core may be positioned within an outer sock of the cellular slat. In such an embodiment, the outer sock may generally form an outer cellular structure of the cellular slat and the core may generally form an inner cellular structure of the slat. However, in other embodiments, the cellular slat may include the slat core without the outer sock, in which case the slat core may form the cellular structure of the cellular slat without an additional outer cellular structure surrounding the core.

It should be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one embodiment can be used separately, or with another embodiment to yield a still further embodiment. Thus, it is intended that the present subject matter covers such modifications and variations as come within the scope of the appended claims and their equivalents.

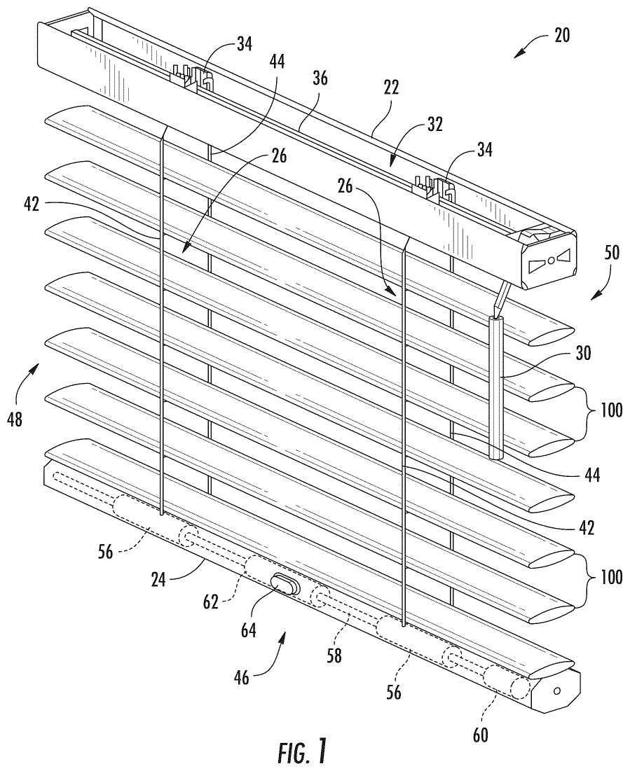

Referring now to the drawings, FIG. 1 illustrates a perspective view of one embodiment of a covering 20 for an architectural structure (not shown) in accordance with aspects of the present subject matter. In general, the covering 20 is configured to be installed relative to a window, door, or any other suitable architectural structure as may be desired. In one embodiment, the covering 20 may be configured to be mounted relative to an architectural structure to allow the covering 20 to be suspended or supported relative to the architectural structure. It should be understood that the covering 20 is not limited in its particular use as a window or door shade, and may be used in any application as a covering, partition, shade, and/or the like, relative to and/or within any type of architectural structure.

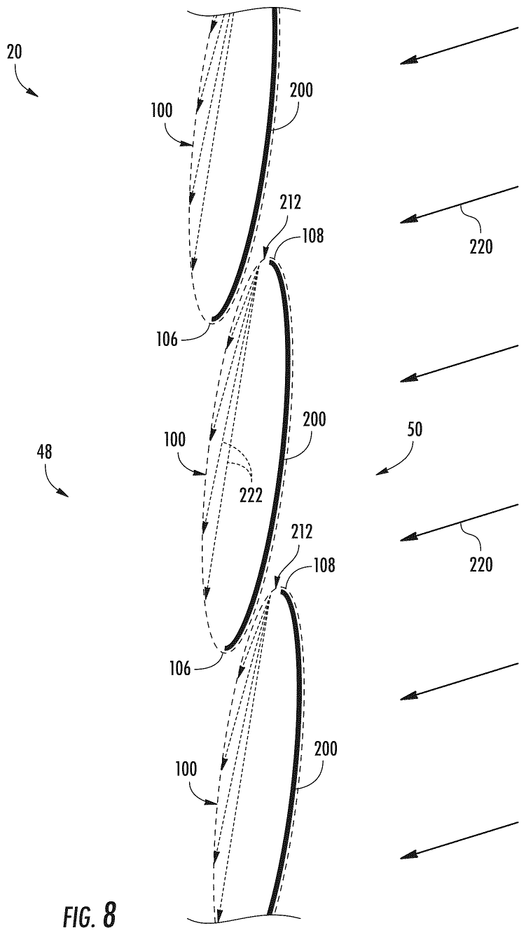

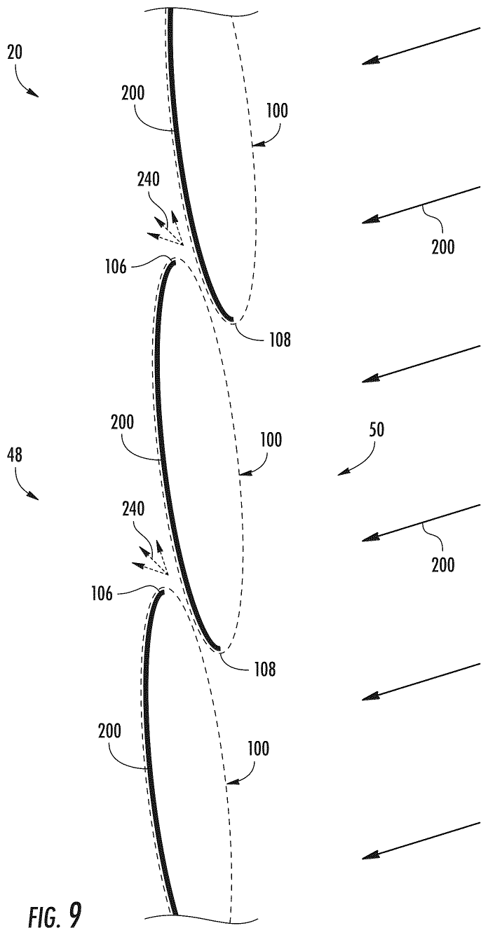

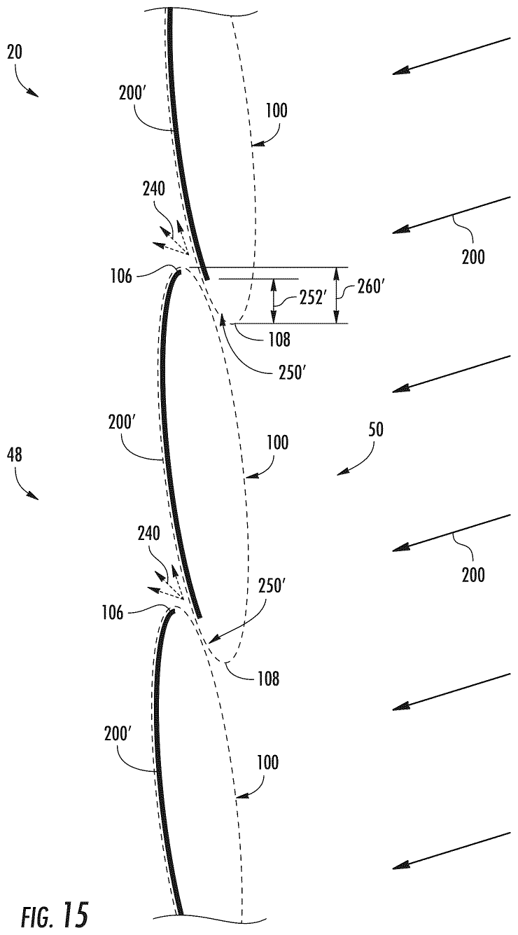

In several embodiments, the covering 20 may be configured as a slatted blind, such as a “privacy” Venetian-blind-type extendable/retractable covering. For example, in the embodiment shown in FIG. 1, the covering 20 includes a headrail 22, a bottom rail 24, and a plurality of horizontally disposed, parallel cellular slats 100 configured to be supported between the headrail 22 and the bottom rail 24 via one or more ladder tape assemblies 26 (e.g., a pair of ladder tape assemblies 26). In several embodiments, the cellular slats 100 are rotatable or tiltable about their longitudinal axes by manipulating the ladder tape assemblies 26 to allow the slats 100 to be tilted between a horizontal or open position (e.g., as shown in FIG. 1) for permitting light to pass between the slats 100 and one of two closed positions (e.g., a first or closed-down position as shown in the partial view of FIGS. 8 and 14 and a second or closed-up position as shown in the partial view of FIGS. 9 and 15), wherein the slats 100 are substantially vertically oriented in an overlapping manner to occlude or block the passage of light through the covering 20.

It should be appreciated that the ladder tape assemblies 26 may be manipulated to allow for the cellular slats 100 to be tilted between their open and closed positions using, for example, a suitable tilt wand 30 or any other suitable control device forming part of a tilt system 32 provided in operative association with the covering 20. For example, as shown in FIG. 1, the covering 20 includes one or more components of the tilt system 32 within the headrail 22, such as a tilt station 34 provided in operative association with each ladder tape assembly 26 and a tilt rod 36 coupled between the tilt wand 30 and the tilt stations 34. In such an embodiment, as the tilt wand 30 is manipulated by the user (e.g., by rotating the tilt wand 30 relative to the headrail 22), the tilt rod 36 may be rotated to rotationally drive one or more tilt drums (not shown) of the tilt stations 34, thereby allowing front and rear ladder rails (not shown) of each ladder tape assembly 26 to be raised or lowered relative to each other to adjust the tilt angle of the cellular slats 100.

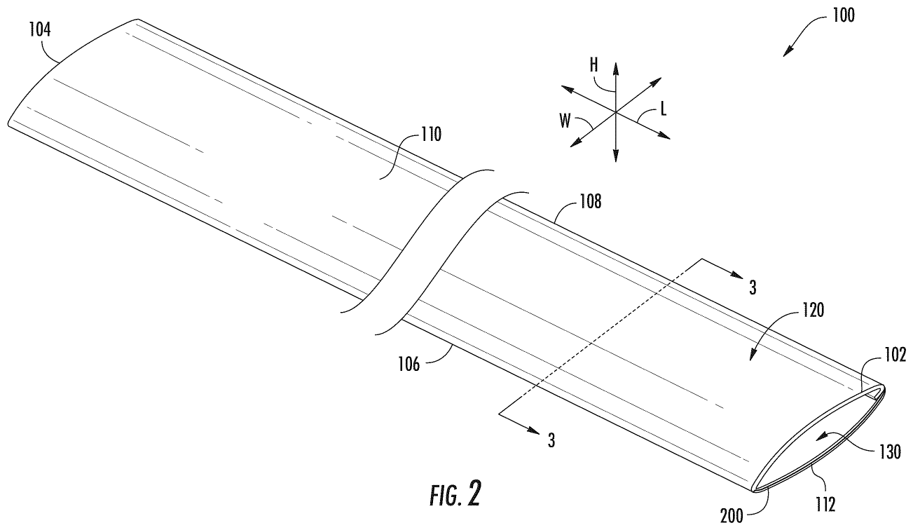

Moreover, as shown FIG. 1, the covering 20 also includes one or more pairs of lift cords 42, 44 forming part of a lift system 46 for moving the covering 20 between a lowered or extended position (e.g., as shown in FIG. 1) and a raised or retracted position (not shown). In the illustrated embodiment, the covering 20 includes two pairs of lift cords 42, 44 extending between the headrail 22 and the bottom rail 24. Each lift cord pair in FIG. 1 includes a front lift cord 42 extending along a front side 48 of the covering 20, and a rear lift cord 44 extending along a rear side 50 of the covering 20. Specifically, each front lift cord 42 is configured to extend between the headrail 22 and the bottom rail 24 along a front edge 106 (FIG. 2) of each cellular slat 100, while each rear lift cord 44 is configured to extend between the headrail 22 and the bottom rail 24 along an opposed rear edge 108 (FIG. 2) of each cellular slat 100.

In one embodiment, each pair of lift cords 42, 44 may be configured to extend to a corresponding lift station 56 to control the vertical positioning of the bottom rail 24 relative to the headrail 22. For instance, in the illustrated embodiment, each pair of lift cords 42, 44 is operatively coupled to a lift station 56 housed within the bottom rail 24. In such an embodiment, a bottom end (not shown) of each lift cord 42, 44 is configured to be coupled to its associated lift station 56 while an opposed end (not shown) of each lift cord 42, 44 is configured to be coupled to the headrail 22. For example, each lift station 56 may include one or more lift spools (e.g., a pair of lift spools) for winding and unwinding the respective lift cords 42, 44 of each pair of lift cords. Thus, as the bottom rail 24 is raised relative to the headrail 22, each lift cord 42, 44 is wound around its respective lift spool. Similarly, as the bottom rail 24 is lowered relative to the headrail 22, each lift cord 42, 44 is unwound from its respective lift spool. Additionally, the lift system 46 of the covering 20 may also include a lift rod 58 operatively coupled to the lift stations 56 and a spring motor 60 operatively coupled to the lift rod 58. In such an embodiment, as is generally understood, the spring motor 60 may be configured to store energy as the bottom rail 24 is lowered relative to the headrail 22 and release such energy when the bottom rail 24 is being raised relative to the headrail 22 to assist in moving the covering 20 to its retracted position.

It should be appreciated that, in one embodiment, the spring motor 60 may be overpowered or underpowered. In such an embodiment, to prevent unintended motion of the bottom rail 24 relative to the headrail 22, a brake assembly 62 may be provided within the bottom rail 24 and may be operatively coupled to the lift rod 58 to stop rotation of the lift rod 58. For instance, as shown in FIG. 1, to actuate the brake assembly 62, an actuator button 64 is coupled to the bottom rail 24 that can be depressed to release or disengage the brake assembly 62 from the lift rod 58, thereby allowing the lift rod 58 to be rotated in a manner that permits the lift cords 42, 44 to be wound around or unwound from their respective lift spools as the bottom rail 24 is lowered or raised, respectively, relative to the headrail 22. In other embodiments, the spring motor 60 may not be overpowered, thereby eliminating the need for the brake assembly 62. For example, in one embodiment, the spring motor 60 may be adapted to provide a variable torque, thereby allowing the lift system 46 to be configured as a balanced operating system.

It should be appreciated that the configuration of the covering 20 described above and shown in FIG. 1 is provided only to place the present subject matter in an exemplary field of use. Thus, it should be apparent that the present subject matter may be readily adaptable to any suitable manner of covering configuration. For example, in other embodiments, the cellular slats 100 described herein may be configured for use within a vertical blind or covering in which the slats 100 are vertically orientated (as opposed to the horizontal orientation shown in FIG. 1). In such embodiments, the cellular slats 100 may, for instance, be suspended from a corresponding headrail or track to allow the slats to hang vertically therefrom relative to an adjacent architectural structure. Additionally, the covering 20 may generally include any suitable type or manner of tilt system and/or lift system.

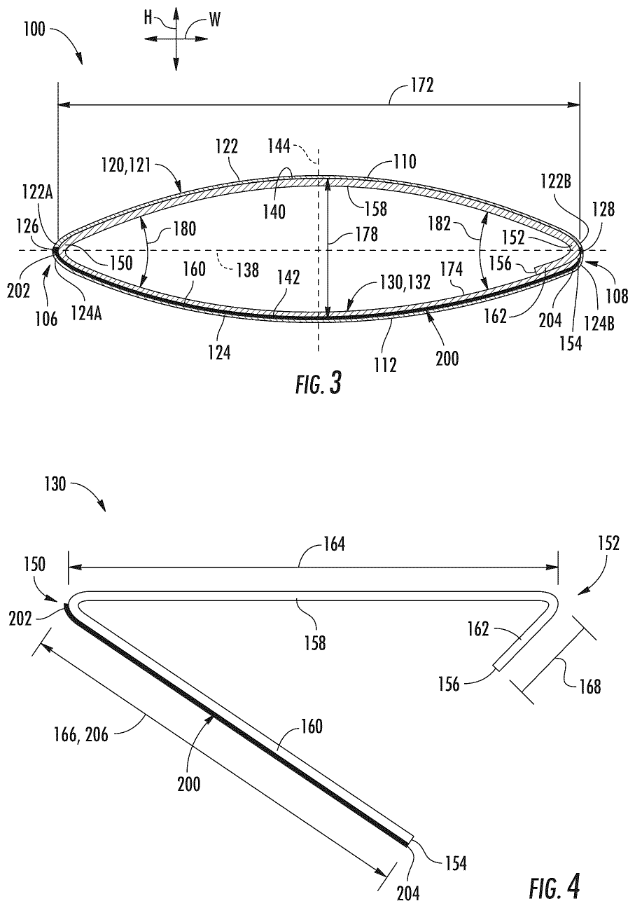

Referring now to FIGS. 2-4, different views of one embodiment of a cellular slat 100 are illustrated in accordance with aspects of the present subject matter. Specifically, FIG. 2 illustrates a perspective view of the cellular slat 100 and FIG. 3 illustrates a cross-sectional view of the slat 100 shown in FIG. 2 taken about line 3-3. Additionally, FIG. 4 illustrates an end view of a slat core 130 of the cellular slat 100 shown in FIGS. 2 and 3 in a non-constrained, disassembled state. It should be appreciated that, for purposes of description, the cellular slat 100 shown in FIGS. 2-4 will generally be described with reference to the covering 20 of FIG. 1. However, in general, the cellular slat 100 disclosed herein may be configured for use with coverings have any other suitable configuration, including any suitable horizontal and/or vertical coverings that incorporate or utilize slats as covering elements.

As particularly shown in FIG. 2, the cellular slat 100 generally extends in a longitudinal direction (as indicated by arrow L in FIG. 2) between a first lateral end 102 and a second lateral end 104 of the slat 100 and in a widthwise direction (as indicated by arrow W in FIGS. 2 and 3) between a front or first outer edge 106 and a rear or second outer edge 108 of the slat 100. In addition, the cellular slat 100 extends in a heightwise direction (as indicated by arrows H in FIGS. 2 and 3) between an upper or first outer face 110 and a lower or second outer face 112 of the slat 100, with the opposed outer faces 110, 112 extending in the widthwise direction W between the outer edges 106, 108 of the slat 100. As indicated above, when the cellular slat 100 is incorporated into a “privacy” Venetian-blind, the slat 100 may be configured to be vertically supported via one or more ladder tape assemblies 26 (e.g., via a rung(s) of each ladder tape assembly 26 extending along the second outer face 112 of the slat 100), with front and rear lift cords 42, 44 extending vertically along the opposed outer edges 106, 108 of the slat 100.

As particularly shown in FIG. 3, in several embodiments, the cellular slat 100 includes both an outer sock 120 and a slat core 130 (referred to hereinafter the “inner core” when described embodiments of the slat 100 including a sock) extending within the outer sock 120. Additionally, in accordance with aspects of the present subject matter, the cellular slat 100 includes a blackout layer 200 provided along one side of the slat 100. As will be described below with reference to FIGS. 8 and 9, the one-sided blackout arrangement provided by the blackout layer 200 may allow the cellular slat 100 to provide different lighting effects or different degrees of light control depending on whether the slat 100 is moved to its first closed position (e.g., closed-down position) or its second closed position (e.g., a closed-up position).

In general, the outer sock 120 has a tube-like or looped configuration extending longitudinally along the entire length of the slat 100 (i.e., from the first lateral end 102 to the second lateral end 104 of the slat 100) that forms an outer cellular structure 121 of the slat 100 and, thus, defines the exterior features of the cellular slat 100. For instance, as shown in FIG. 3, the sock 120 generally forms a closed-perimeter cell along the outer perimeter of the slat 100 that defines the opposed outer faces 110, 112 and outer edges 106, 108 of the slat 100. In several embodiments, the outer sock 120 is formed from a flexible material. For instance, the outer sock 120 may be formed from a fabric material, such as a woven or non-woven fabric material. In one embodiment, the fabric material may be formed from thermoplastic fibers, such as polyester, nylon, or polyolefin fibers, or from any other suitable synthetic or natural fibers.

In one embodiment, to provide the tube-like or looped configuration of the outer sock 120, the sock 120 is formed from two separate strips of material (e.g., two separate strips of fabric material) that are joined together end-to-end at opposed seams or joints. Specifically, as shown in FIG. 3, the sock 120 is formed from first and second strips of material 122, 124 extending between the outer edges 106, 108 of the slat 100 such that the first strip of material 122 generally defines the first outer face 110 of the slat 100 and the second strip of material 124 generally defines the second outer face 112 of the slat 100. As shown in the illustrated embodiment, a first end 122A of the first strip of material 122 is coupled or connected to an adjacent first end 124A of the second strip of material 124 via a first joint 126 formed at the first outer edge 106 of the slat 100, while an opposed second end 122B of the first strip of material 122 is coupled or connected to the adjacent second end 124B of the second strip of material 124 via a second joint 128 formed at the second outer edge 108 of the slat 100. It should be appreciated that the joints 126, 128 provided between the adjacent ends of the strips of material 122, 124 may generally be formed using any suitable joining or connection means and/or methodology. For instance, in one embodiment, the adjacent ends of the material strips 122, 124 may be welded or bonded together using an ultrasonic sealing method to create ultrasonic slit/weld joints at the connection points between the strips 122, 124. Alternatively, the joints 126, 128 may correspond to lap joints at which the adjacent ends of the strips of material 122, 124 are overlapped and then coupled together using any suitable connection/coupling means (e.g., adhesives, stitching, sewing, tape, and/or the like).

In another embodiment, the outer sock 120 may be formed from a single strip of material (e.g., a strip of fabric material) that has been placed in a looped arrangement and coupled end-to-end at a single joint to form the tube-like configuration of the sock 120. In such an embodiment, similar to the embodiment described above, the joint provided between the adjacent ends of the single strip of material may generally be formed using any suitable joining or connection means and/or methodology.

In several embodiments, the outer sock 120 may be configured to constrain and envelop the inner core 130, with the core 130 functioning as a stiffening element to provide structural integrity to the cellular slat 100. However, while the outer sock 120 generally functions to constrain/contain the inner core 130, the core 130 is configured, in several embodiments, to be positioned within the outer sock 120 in a partially or completely detached state relative to the sock 120. Specifically, when installed within the outer sock 120, the inner core 130 is configured to be detached from the outer sock 120 along at least a portion of an interface defined between the outer sock 120 and the inner core 130 (i.e., the interface defined between the inner perimeter of the sock 120 and the outer perimeter of the core 130). For example, in one embodiment, the inner core 130 may be completely detached from the outer sock 120 such that the core 130 is not coupled or connected to the sock 120 at any location along the interface defined between such components. In such an embodiment, the inner core 130 may be freely movable relative to the outer sock 120, which can be advantageous in instances in which the sock/core are formed from different materials having differing coefficients of thermal expansion. For instance, in embodiments in which the outer sock 120 is formed from a fabric material while the inner core 130 is formed from a polymer-based film material (as described below), the differing coefficients of thermal expansion of such materials would result in the sock 120 expanding/contracting at significantly different rates than the core 130, particularly at extreme temperatures. By providing the inner core 130 in a non-laminated, detached condition or state relative to the outer sock 120, such components can expand/contract relative to one another in a manner that allows any stresses causes by temperature fluctuations and other environmental conditions to be relieved, thereby eliminating the potential for any undesirable deformations, warping and/or other thermal or stress-related issues within the resulting cellular slat 100.

As an alternative to providing the inner core 130 in a completely detached state relative to outer sock 120, the inner core 130 may, instead, only be provided in a partially detached state relative to the outer sock 120, such as a state in which the core 130 is attached or connected to the sock 120 along the interface defined between such components at one or more isolated locations. For instance, in one embodiment, the inner core 130 may be connected to the outer sock at a very localized region(s) or specific location(s) across interface defined between the sock 120 and the core 130 (e.g., via a localized glue bead(s) applied between the outer sock 120 and the inner core 130 that runs along the length of the slat 100 in the longitudinal direction L). Such a localized attachment point(s) may, for instance, provide a connection between the outer sock 120 and the inner core 130 while still allowing such components to expand/contract relative to one another to relieve any temperature-induced stresses.

Referring still to FIGS. 2-4, in several embodiments, the inner core 130 of the cellular slat 100 generally corresponds to a folded strip of material that is configured to form an inner cellular structure 132 within the interior of the sock 120 that provides stiffness and rigidity to the otherwise flexible sock 120. In addition, the inner cellular structure 132 formed by the inner core 130 also functions to create and maintain the desired shape of the cellular slat 100. For example, as will be described below, the inner core 130 may be folded or creased at spaced apart locations to provide two fold edges that form the opposed vertices of the inner cellular structure 132 (e.g., the vertices formed at the first and second fold edges 150, 152 shown in FIG. 3) when the core 130 is positioned within the sock 120. In such an embodiment, with the inner core 130 dimensionally constrained within the outer sock 120, the core 130 has a tendency to “spring-open” at the vertices or fold edges 150, 152 causing the core 130 to “puff-up” or expand outwardly in the heightwise direction H relative to an edge-to-edge or widthwise centerline 138 of the slat 100, thereby creating a cellular structure 132 having curved walls extending between the opposed vertices/folds 150, 152. As shown in FIG. 3, the opposed vertices/folds 150, 152 of the inner cellular structure 132 are generally positioned adjacent to and aligned with the outer edges 106, 108 of the cellular slat 100 (and, thus, the sock joints 126, 128 formed at the outer edges 106, 108) such that the curved walls of the cellular structure 132 generally extend parallel to and shape the outer faces 110, 112 of the cellular slat 100. With such positioning of the fold edges 150, 152, the slat 100 is generally provided with a uniform amount of edge stiffness at each of its outer edges 106, 108.

As shown in the illustrated embodiment, the inner cellular structure 132 formed by the core 130 defines a closed-perimeter or substantially closed-perimeter cell having a first curved profile along a first side 140 of the cellular structure 132 and a second curved profile along a second side 142 of the cellular structure 132, with the curved profiles generally extending in the widthwise direction W between the opposed vertices/folds 150, 152 of the cellular structure 132. The curved profiles are generally arced or curved outwardly such that the outer perimeter of the inner cellular structure 132 is characterized by opposed concave surfaces extending between the vertices/folds 150, 152, thereby providing the inner cellular structure 132 with a shape that is symmetrical or substantially symmetrical about the widthwise centerline 138 of the slat 100 Additionally, as shown in FIG. 3, due to the configuration of the inner core 130, the shape of the inner cellular structure 132 is also symmetrical or substantially symmetrical about a vertical or heightwise centerline 144 of the slat 100.

Referring briefly to FIG. 4, the general structure and configuration of the embodiment of the inner core 130 of the cellular slat shown in FIGS. 2 and 3 will now be described. It should be appreciated that the inner core 130 is shown in FIG. 4 in its non-constrained, disassembled state (i.e., relative to the outer sock 120). As will be described below, when the inner core 130 is positioned within the outer sock 120, the sock 120 dimensionally constrains the inner core 130, thereby allowing the core 130 to form the inner cellular structure 132 shown in FIG. 3.

As shown in FIG. 4, in several embodiments, the core 130 is formed from a flat strip of material that has been folded or creased at two spaced apart locations to form first and second fold edges 150, 152 disposed between opposed ends of the core 130 (e.g., first and second ends 154, 156 of the core 130). Such a twice-folded configuration generally divides the inner core 130 into three wall segments extending between/from the folds, with adjacent wall segments intersecting each other or otherwise being connected together at each fold edge 150, 152. Specifically, as shown in FIG. 4, the folded inner core 130 includes a central or base wall segment 158 extending directly between the first and second fold edges 150, 152. Additionally, the inner core 130 includes first and second folded wall segments 160, 162 extending from the base wall segment 158 at the first and second fold edges 150, 152, respectively, with the first folded wall segment 160 extending directly between the first fold edge 150 and the first end 154 of the inner core 130 and the second folded wall segment 162 extending directly between the second fold edge 152 and the second end 156 of the inner core 130. As shown, due to the relative positioning of the fold edges 150, 152 between the opposed ends 154, 156 of the inner core 130, the base wall segment 158 and the first folded wall segment 160 generally define substantially the same length (e.g., a base segment length 164 and a first folded segment length 166), while the second wall segment 162 defines a shorter length (e.g., a second folded segment length 168) than the other two wall segments 158, 160. However, in other embodiments, the various wall segments 158, 160, 162 may be configured to define any other suitable lengths relative to one another. For instance, in one embodiment, the second wall segment 162 may be configured to define the same or substantially the same length as the other two wall segments 158, 160.

In several embodiments, the inner core 130 is formed from a thin-walled material, such as a film material. For instance, in one embodiment, the inner core 130 may be formed from a polyester film, such as a biaxially oriented polyethylene terephthalate (PET) film (e.g., commercially available as MYLAR®). However, in other embodiments, the inner core 130 may be formed from other suitable film materials, such as various other suitable polymer-based film materials. In one embodiment, the specific film material used to form the inner core 130 may be selected based on the desired properties of the material, such as the tendency for the material to want to spring back towards an original flat or non-folded state upon being folded. Such a tendency facilitates the creation of the outward spring force at the fold edges 150, 152 when the inner core 130 is in its dimensionally constrained, assembled state within the outer sock 120. Additionally, in one embodiment, the film material used to form the inner core 130 may correspond to a commercially available pre-shrunk film material to prevent shrinkage issues or to otherwise provide dimensional stability to the material when exposed to extreme temperatures, particularly when exposure to a higher temperature range is anticipated.

In addition, a thickness of the film material may be selected to provide the desired structural integrity to the cellular slat 100 while also providing sufficient outward spring force at the fold edges 150, 152. For instance, in one embodiment, the thickness of the film material forming the inner core 130 may range from 0.002 inches to 0.010 inches, such as from 0.003 inches to 0.009 inches, or from 0.004 inches to 0.007 inches, and/or any other subranges therebetween. However, it should be appreciated that material thicknesses outside the thickness ranges described above may also be utilized, depending on the properties of the material being used to form the core 130 and/or the desired characteristics of the core 130 and/or the resulting cellular slat 100.

It should also be appreciated that the light transmissivity of the film material may also be varied to adjust the light-transmission characteristics of the cellular slat 100. For instance, in several embodiments, the inner core 130 may be formed from a clear film material. In another embodiment, the inner core 130 may be formed from a translucent film material.

As shown in FIG. 4, each wall segment 158, 160, 162 of the inner core 130 generally defines a straight or non-curved profile along its length when the core 130 is in its non-constrained, disassembled state. However, with the core 130 positioned within the outer sock 120, the wall segments 158, 160, 162 take on the curved profiles of the inner cellular structure 132 described above. Specifically, referring back to FIG. 3, the base wall segment 158 of the inner core 130 generally defines the first curved profile extending along the first side 140 the inner cellular structure 132, while the first folded wall segment 160 generally defines the second curved profile extending along the second side 142 of the inner cellular structure 132. As indicated above, such curving or arcing of the wall segments 158, 160 generally occurs as a result of the outward spring force provided via the fold edges 150, 152 when the core 130 is dimensionally constrained within the outer sock 120. For example, in one embodiment, the segment lengths 164, 166 (FIG. 4) of the base wall segment 158 and the first folded wall segment 160 may be greater than an inner width 172 (FIG. 3) of the outer cellular structure 121 defined by the outer sock 120 in the widthwise direction W. As such, with the inner core 130 positioned within the outer sock 120, the sock 120 may dimensionally constrain the core 130 in the widthwise direction W, thereby causing the base wall segment 158 and the first folded wall segment 160 to transition into the outwardly curved profiles via the spring force provided at the fold edges 150, 152.

Referring still to FIG. 3, as indicated above, the base wall segment 158 of the inner core 130 generally defines the first curved profile of the inner cellular structure 132, while the first folded wall segment 160 generally defines the second curved profile of the inner cellular structure 132. Specifically, the base wall segment 158 defines the curved profile extending along the first side 140 of the inner cellular structure 132 between the first and second vertices/folds 150, 152 of the inner cellular structure 132. Similarly, the first folded wall segment 160 defines the curved profile extending along the second side 142 of the inner cellular structure 132 between the first and second vertices/folds 150, 152 of the inner cellular structure 132. In this regard, it should be noted that the first folded wall segment 160 generally extends along the entire width of the inner cellular structure 132 from the first vertex or fold edge 150 to the second vertex or fold edge 152, with the first folded wall segment 160 terminating at or adjacent to the second fold edge 152. Specifically, as shown in FIG. 3, the first end 154 of the inner core 130 (which also forms the end of the first folded wall segment 160 opposite the first fold edge 150) is generally positioned adjacent to the second fold edge 152. Thus, with the inner core 130 dimensionally constrained within the outer sock 120, both the base wall segment 158 and the first folded wall segment 160 generally extend substantially across the entire inner width of the outer cellular structure 121 formed by the sock 120.

Additionally, as shown in FIG. 3, the first and second folded wall segments 160, 162 are generally configured to at least partially overlap each other when the core 130 is formed into the inner cellular structure 132. Specifically, the second folded wall segment 162 of the inner core 130 is generally configured to overlap the first folded wall segment 160 along a portion of the second side 142 of the inner cellular structure 132. For example, as shown in FIG. 3, the second folded wall segment 162 generally extends from the second vertex or fold edge 152 into an interior of the inner cellular structure 132 along an inner surface 174 of the first folded wall segment 160 so that the folded wall segments 160, 162 overlap each other along a given overlapped region. In one embodiment, the second folded wall segment 162 may simply extend along the inner surface 174 of the first folded wall segment 160 without being coupled to such wall segment 160 at any point across the overlapped region. In such an embodiment, the dimensional constraint provided to the inner core 130 by the outer sock 120 may function to maintain the first and second folded wall segments 160, 162 in their overlapped state or condition, as well as to generally maintain the inner core 130 in its cellular configuration.

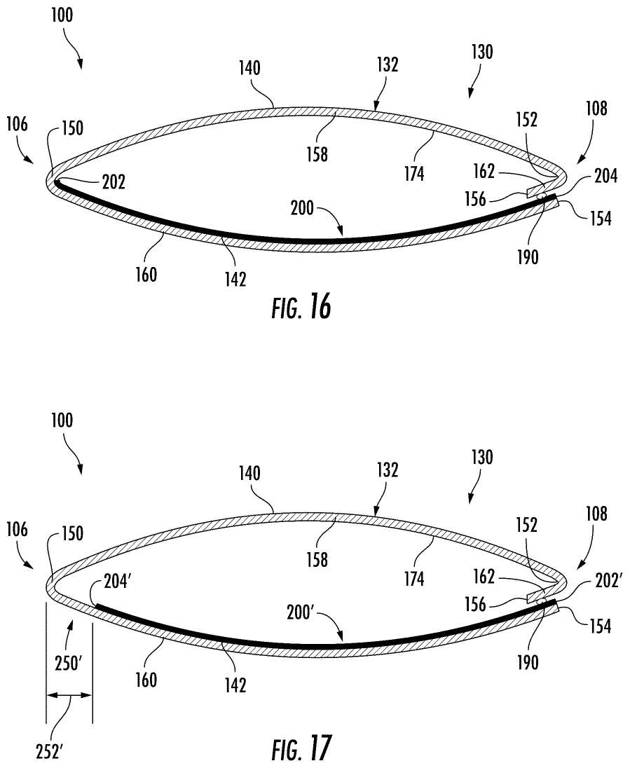

Alternatively, the first and second folded wall segments 160, 162 may, instead, be coupled together at the location of the overlap defined therebetween, thereby providing a lap joint or connection between the folded wall segments 160, 162 that can maintain the cellular configuration of the inner core 130 independent of the outer sock 120. By connecting the folded wall segments 160, 162 together in this manner, the inner core 130 may be configured to be maintained in its cellular configuration independent of the outer sock 120. For instance, a lap joint may be formed via application of an adhesive (e.g., a glue bead) at the overlapped interface defined between the first and second folded wall segments 160, 162. In another embodiment, any other suitable connection/joining means or methodology (e.g., tape, welding, etc.) may be used to form the lap joint between the folded wall segments 160, 162. Regardless of the connection/joining means or methodology utilized, by connecting the folded wall segments 160, 162 together such that the slat core 130 maintains its cellular configuration independent of the outer sock 120, the core 130 may, itself, be configured to be utilized as a cellular slat independent of the outer sock 120. Specifically, as indicated above, in one embodiment, the slat core 130 may form the cellular structure of the cellular slat 100 without an additional outer cellular structure surrounding the core 130 (e.g., with inclusion of the outer sock 120). An example of this configuration is illustrated in FIG. 16, which shows the folded wall segments 160, 162 of the slat core 130 connected together (e.g., via a glue bead 190) such that core 130, itself, forms a cellular structure (e.g., structure 132) that can be used as a cellular slat independent of outer sock 120.

As indicated above, the second folded wall segment 162 may be configured to define a segment length 168 that is shorter than the lengths 164, 166 of the other wall segments 158, 160 of the inner core 130. However, it should be appreciated that, in general, the overall length 168 of the second folded wall segment 162 (and the length of associated overlapped region defined between first and second folded wall segments 160, 162) may be selected such that the length 168 is, at a minimum, sufficient to allow the same or similar outward spring force to be exerted at the second fold edge 152 as that exerted at the first fold edge 150, thereby allowing the core 130 to uniformly “puff-out” or expand outwardly in the heightwise direction H across the width of the slat 100 to form the symmetrically curved inner cellular structure 132 disclosed herein. For instance, in one embodiment, the length 168 of the second folded segment 162 may be equal to or greater than 0.25 inches, such as a length ranging from 0.25 inches to 1 inch or from 0.25 inches to 0.5 inches and/or any other subranges therebetween. In other embodiments, depending on the overall size of the slat 100, the length 168 of the second folded wall segment 162 may be less than or greater than the above-referenced length range, including being the same or substantially the same as the lengths 164, 166 of the other wall segments 158, 160 of the inner core 130. For example, in one alternative embodiment, the length 168 of the second folded wall segment 162 may be selected such that the wall segment 162 extends along or overlaps the inner surface 174 of the first folded wall segment 160 from the second fold edge 152 to a location at or adjacent to the first fold edge 150.

As shown in FIG. 3, with the inner core 130 positioned within the outer sock 120, the inner cellular structure 132 defines a cell height 178 in the heightwise direction H between the opposed first and second sides 140, 142 of the inner cellular structure 132 that is generally a function of an inner cell angle formed at each of the vertices or fold edges 150, 152 of the inner core 130 (e.g., a first inner cell angle 180 and a second inner cell angle 182). Specifically, the height 178 of the inner cellular structure 132 is generally proportional to the magnitude of inner cell angles 180, 182, with the cell height 178 generally increasing with increases in the inner cell angles 180, 182 (and vice versa). As such, the inner cell angle 180, 182 defined at each vertex or fold edge 150, 152 may generally be selected to provide the desired cell height 178 and, thus, the desired overall shape of the resulting cellular slat 100. For instance, in one embodiment, each of the inner cell angles 180, 182 may correspond to an angle ranging from 10 degrees to 35 degrees, such as from 15 degrees to 30 degrees or from 20 degrees to 25 degrees and/or any other subranges therebetween. It should be appreciated that, in one embodiment, the inner cell angle 180 formed at the first vertex or fold edge 150 may be the same as or substantially the same as the inner cell angle 182 formed at the second vertex or fold edge 152. However, in other embodiments, the first and second inner cell angles 180, 182 may correspond to different angles, such as when different inner cell angles are needed to achieve the desired shape for the cellular slat 100 (e.g., a desired symmetrical shape). For instance, depending on the thickness of the material used to form the inner core 130, the second inner cell angle 182 may need to be slightly smaller than the first inner cell angle 180 to provide a symmetrical cell shape given the overlap between the first and second folded wall segments 160, 162 at the second vertex or fold edge 152.

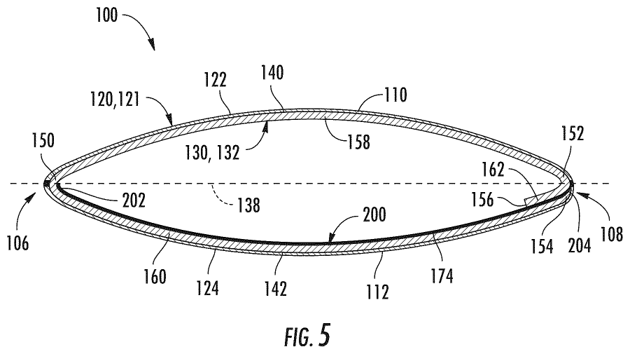

As indicated above, the cellular slat 100 may have a one-sided blackout arrangement provided by a blackout layer 200 that is positioned along only one side of the slat 100 and that extends in the longitudinal direction L between the opposed lateral ends 102, 104 of the slat 100. Specifically, in several embodiments, the blackout layer 200 may be positioned relative to the cellular slat 100 such that the layer 200 is only disposed along one side of the lateral centerline 138 of the slat 100, such as by positioning the blackout layer 200 along either the first side 140 or the second side 142 of the inner cellular structure 132 formed by the inner core 130. For instance, in the illustrated embodiment, the blackout layer 200 is positioned along the second side 142 of the inner cellular structure 132. In particular, as shown in FIG. 3, the blackout layer 200 is provided directly between the first wall segment 160 of the inner core 130 and the outer sock 120 such that the layer 200 extends across the second side 142 of the inner cellular structure 132 along the exterior of such structure 132. Alternatively, the blackout layer 200 may be provided along the inner surface 174 of the first wall segment 160 of the inner core 130 such that the layer 200 extends across the second side 142 of the inner cellular structure 132 within the interior of such structure 132. An example of such an embodiment is shown in the cross-sectional view of FIG. 5, which illustrates the same view of the outer sock 120 and inner core 130 of the cellular slat 100 shown in FIG. 3 but with the blackout layer 200 extending across the inner surface 174 of the first wall segment 160 of the inner core 130 along the second side 142 of the inner cellular structure 132.

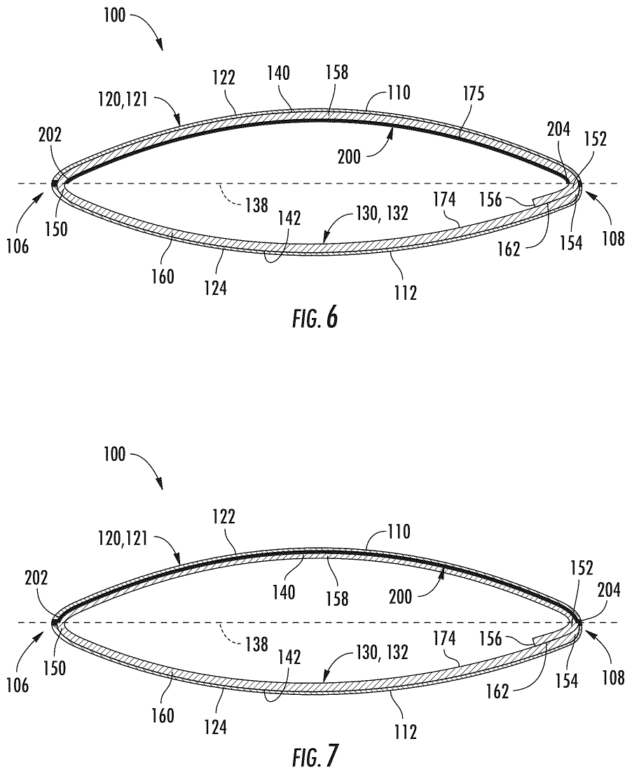

Alternatively, the blackout layer 200 may be positioned along the first side 140 of the inner cellular structure 132 formed by inner core 130. For instance, in one embodiment, the blackout layer 200 may be provided along an inner surface 175 (FIG. 6) of the base wall segment 158 of the inner core 130 such that the layer 200 extends across the first side 140 of the inner cellular structure 132 within the interior of such structure 132. An example of such an embodiment is shown in the cross-sectional view of FIG. 6, which illustrates the same view of the outer sock 120 and inner core 130 of the cellular slat 100 shown in FIG. 3 but with the blackout layer 200 extending across the inner surface 175 of the base wall segment 158 of the inner core 130 along the first side 140 of the cellular structure 132. In another embodiment, the blackout layer 200 may be provided between the base wall segment 158 of the inner core 130 and the outer sock 120 such that the layer 200 extends across the first side 140 of the inner cellular structure 132 along the exterior of such structure 132. An example of such an embodiment is shown in the cross-sectional view of FIG. 7, which illustrates the same view of the outer sock 120 and inner core 130 of the cellular slat 100 shown in FIG. 3 but with the blackout layer 200 positioned between the outer sock 120 and the inner core 130 along the first side 140 of the cellular structure 132.

Referring back to FIGS. 3 and 4, in several embodiments, the blackout layer 200 may be configured to extend across the entirety of either the first side 140 or the second side 142 of the inner cellular structure 132, such as by extending across the entirety of the curved profile defined by the first wall segment 160 or the base wall segment 160 between the first and second fold edges 150, 152 of the inner core 130. For instance, as particularly shown in FIG. 4, the blackout layer 200 generally extends lengthwise between a first end 202 and an opposed second end 204, with the first end 202 of the layer 200 generally terminating at the first fold edge 150 of the inner core 130 and the second end 204 of the layer generally terminating at the first end 154 of the inner core 130 so that the layer 200 extends along the entire length 166 of the first wall segment 160 of the inner core 130. For instance, in one embodiment, a length 206 of the blackout layer 200 defined between its opposed ends 202, 204 may generally be equal to the length 166 of the first wall segment 160. As a result, when the inner core 130 is formed into the inner cellular structure 132, the blackout layer 200 may generally extend across the entire length of the second side 142 of the inner cellular structure 132. Similarly, in embodiments in which the blackout layer 200 is positioned along the first side 140 of the inner cellular structure 132, the blackout layer 200 may be provided along the entire length 164 of the base wall segment 158 of the inner core 130 (e.g., from the first fold edge 150 to the second fold edge 152). In such embodiments, when the inner core 130 is formed into the inner cellular structure 132, the blackout layer 200 may generally extend across the entire length of the first side 140 of the inner cellular structure 132 (e.g., as shown in the embodiments of FIGS. 6 and 7).

It should be appreciated that blackout layer 200 may generally be provided in association with the components of the cellular slat 100 in any suitable manner. For instance, in embodiments in which the blackout layer 200 is positioned along the exterior of the inner cellular structure 132 formed by the inner core 130 (e.g., between the first wall segment 160 and the outer sock 120 as shown in FIG. 4 or between the base wall segment 158 and the outer sock 120 as shown in FIG. 7), the blackout layer 200 may correspond to a separate layer of blackout material that is coupled to the respective wall segment 158, 160 or the adjacent section of the outer sock 120 (e.g., via heat tacking, adhesives, etc.) or a separate layer of blackout material that is simply positioned between such components (e.g., without being secured or coupled to either component), as applicable. Alternatively, in such embodiments, the blackout layer 200 may correspond to a coating that is applied to either the outer surface of the respective wall segment 158, 160 or the adjacent inner surface of the fabric sock 120, as applicable. Similarly, in embodiments in which the blackout layer 200 is positioned within the interior of the inner cellular structure 132 formed by the inner core 130 (e.g., along the inner surface 174 of the first wall segment 160 as shown in FIG. 5 or along the inner surface 175 of the base wall segment 158 as shown in FIG. 6 or as shown in FIG. 16 with the sockless embodiment of the slat 100), the blackout layer 200 may correspond to a separate layer of blackout material that is coupled to the respective wall segment 158, 160 (e.g., via heat tacking, adhesives, etc.) or the blackout layer 200 may correspond to a coating that is applied to the inner surface 174, 175 of the respective wall segment 158, 160.

Referring now to FIGS. 8 and 9, partial, side views of the covering 20 described above with reference to FIG. 1 with cellular slats 100 having the configuration shown in FIGS. 2-4 installed relative thereto and being tilted to respective closed positions are illustrated in accordance with aspects of the present subject matter. Specifically, FIG. 8 illustrates the slats 100 tilted to their first closed position (e.g., a closed-down position) such that the front edges 106 of the slats 100 face downwardly along the front side 48 of the covering 20 and the rear edges 108 of the slats 100 face upwardly along the rear side 50 of the covering 20. Additionally, FIG. 9 illustrates the slats 100 tilted to their second closed position (e.g., a closed-up position) such that the front edges 106 of the slats 100 face upwardly along the front side 48 of the covering 20 and the rear edges 108 of the slats 100 face downwardly along the rear side 50 of the covering 20. For purposes of illustration, each cellular slat 100 is shown schematically as a dashed oval 100, while the inner blackout layer 200 of each cellular slat 100 is shown schematically as a solid line 200. It should be appreciated that the description of FIGS. 8 and 9 generally applies regardless of whether the cellular slats 100 include both an outer sock and an inner core or are configured as sockless slats similar to that shown in FIG. 16.

As shown in FIGS. 8 and 9, when tilted to their respective closed positions, the slats 100 are generally configured to be provided in an overlapping arrangement such that the front edge 106 of each slat 100 is either positioned below the rear edge 108 of the adjacent slat 100 (when in the closed-down position shown in FIG. 8) or above the rear edge 108 of the adjacent slat 100 (when in the closed-up position shown in FIG. 9). In an ideal state, the slats 100 are configured to be closed tightly against one another such that the overlapping arrangement results in no light gaps being defined at the interfaces between the adjacent slats 100 (hereinafter referred to as “slat-to-slat interfaces). However, in practice due to imperfections in the slat-to-slat closure or due to imperfections in the slats 100 themselves (i.e., deviations from the ideal state), small, non-uninform light gaps or cracks exist across portions of the slat-to-slat interfaces that allow light (e.g., indicated by arrows 220) to pass therethrough from the rear side 50 to the front side 48 of the covering 20. As a result, if the cellular slats 100 were formed with blackout layers extending across the entirety of both sides of the cellular structure formed by the inner core (e.g., a dual-sided or full blackout arrangement), the light entering the small gaps or cracks defined at the slat-to-slat interfaces would be channeled through the gaps to the front side 48 of the covering 20 and provide a stark contrast relative to the otherwise blacked-out slats, thereby highlighting the imperfections and making the non-uninform light gaps or cracks highly noticeable across the front side 48 of the covering 20. In contrast, the one-sided blackout arrangement described herein allows for such imperfections to remain significantly or entirely hidden from view. In addition, the one-sided blackout arrangement allows for different lighting effects to be provided depending on whether the slats 100 are tilted to the closed-down position or the closed-up position.

As particularly shown in FIG. 8, with the slats 100 tilted to the closed-down position such that the blackout layer 200 of each slat 100 is positioned along the rear side 50 of the covering 20, any light entering the small gaps or cracks defined at the slat-to-slat interfaces from the rear side 50 of the covering 20 is allowed to pass through the adjacent, non-blacked-out portions of the slats 100 positioned at the interfaces (e.g., cell portions 212) and into the interior of the slats 100, at which point the light is diffused across the interior of the slat 100 (as indicated by arrows 222). As a result of such light diffusion through each slat 100, the slats 100 will have a soft glow or soft lighting effect along the front side 48 of the covering 20 that provides a generally aesthetically pleasing look to the covering 20 and also serves to hide or render virtually unnoticeable any imperfections provided at the slat-to-slat interfaces.

Additionally, as shown in FIG. 9, with the slats 100 tilted to the closed-up position such that the blackout layers 200 are positioned along the front side 48 of the covering 20, the slats 100 will have a much darker appearance across the front side 48 of the covering 20 with soft reveal lines (indicated by arrows 240) being provided at the slat-to-slat interfaces. Specifically, the blackout layers 200 will generally block light from passing through the slats 100 along the front side 48 of the covering 20. However, due to the one-sided blackout arrangement, a small amount of diffuse light will be allowed to pass through the covering 20 at the slat-to-slat interfaces to provide a very soft, uniform reveal line 240 between each adjacent pair of slats 100 that hides or renders virtually unnoticeable any imperfections defined at the slat-to-interfaces.

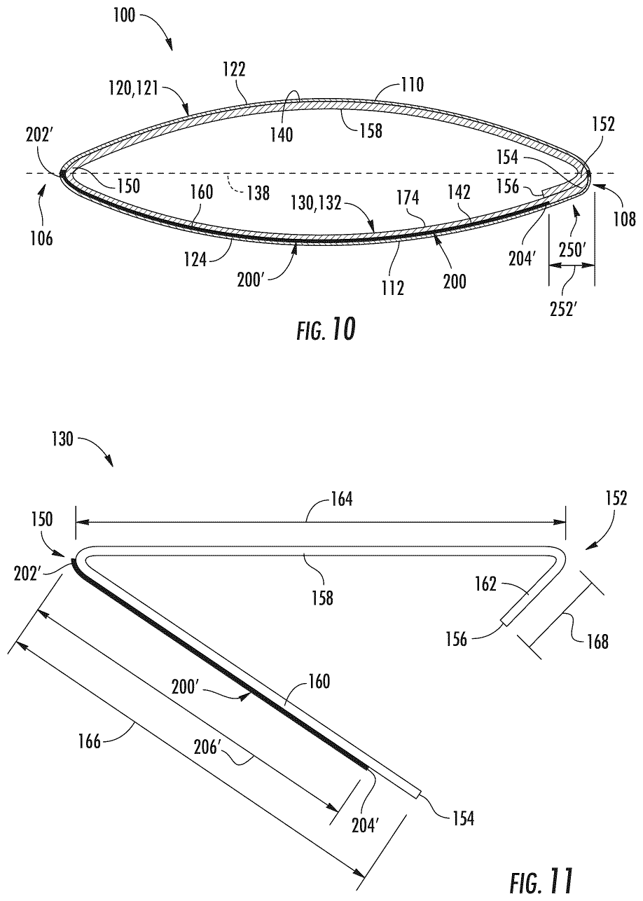

Referring now to FIGS. 10 and 11, different views of another embodiment of a blackout layer 200′ that may be provided in association with a cellular slat 100 in a one-side blackout arrangement are illustrated in accordance with aspects of the present subject matter. Specifically, FIGS. 10 and 11 illustrate the same views of the outer sock 120 and inner core 130 shown in FIGS. 3 and 4 with a different embodiment of a blackout layer 200′ installed relative thereto.

As shown in FIGS. 10 and 11, similar to the various embodiments described above, the blackout layer 200′ is configured to be positioned within a portion of the cellular slat 100 such that the layer 200′ is only disposed along one side of the lateral centerline 138 of the slat 100, such as by positioning the blackout layer 200′ along either the first side 140 or the second side 142 of the inner cellular structure 132 formed by the inner core 130. For instance, in the illustrated embodiment, the blackout layer 200′ is positioned along the second side 142 of the inner cellular structure 132. In particular, as shown in FIG. 10, the blackout layer 200′ is provided directly between the first wall segment 160 of the inner core 130 and the outer sock 120 such that the layer 200 extends across the second side 142 of the inner cellular structure 132 along the exterior of such structure 132. However, in other embodiments, the blackout layer 200′ may be provided along the inner surface 174 of the first wall segment 160 of the inner core 130 (e.g., in a manner similar to that shown in FIG. 5) or along the first side 140 of the inner cellular structure 132 (e.g., in a manner similar to that shown in FIG. 6 or FIG. 7).

However, unlike the various embodiments described above, the blackout layer 200′ is configured to extend only partially across the side of the slat 100 on which the layer 200′ is positioned. For instance, as shown in FIG. 11, the blackout layer 200′ extends only partially across the length 166 of the first wall segment 160 of the inner core 130.

Specifically, as shown in the illustrated embodiment, the blackout layer 200′ extends along the outer surface of the first wall segment 160 from a first end 202′ positioned adjacent to the first fold edge 150 to a second or “slot” end 204′ that is spaced apart from the first end 154 of the inner core 130 such that the layer 200 defines a length 206′ that is shorter than the length 166 of the first wall segment 160. As a result, when the inner core 130 is formed into the inner cellular structure 132 (e.g., as shown in FIG. 10), a light-transmissible slot 250′ may be defined between the slot end 204′ of the blackout layer 200′ and the adjacent edge of the slat 100 (e.g., the rear edge 108). For example, as shown in FIG. 10, the slot 250′ defined between the slot end 204′ of the blackout layer 200′ and the rear edge 108 of the slat 100 generally extends in the widthwise direction of the slat 100 across a given slot distance 252′. As will be described below, this slot distance 252′ may be selected based on a corresponding overlap distance 260′ (FIG. 15) of the slats 100 to provide different lighting effects depending on which direction the slats 100 are closed. For instance, the light-transmissible slot 250′ may allow a certain amount of light to pass into each cell 100 (e.g., through the portions of the outer sock 120 and inner core 130 positioned at the slot 250′) along the rear side 50 of the covering 20 when the slats 100 are at one closed position (e.g., the closed-down portion), but may be blocked or vertically overlapped by a portion of the blackout layer 200 of an adjacent slat 100 when the slats 100 are at the other closed position to provide a darkened look across the front side 48 of the covering 29 with soft, uniform reveal lines.

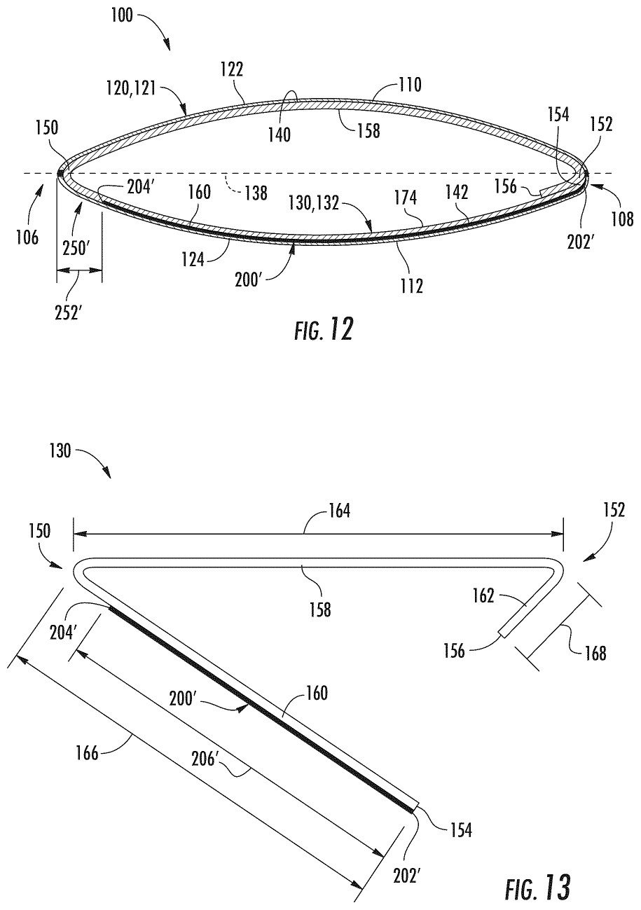

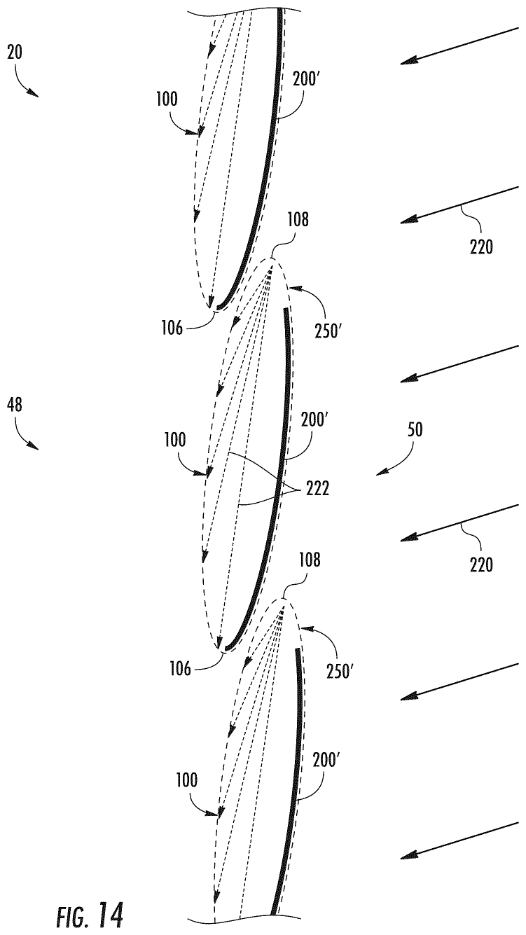

Referring now to FIGS. 12 and 13, similar views of the outer sock 120 and inner core 130 shown in FIGS. 10 and 11 with the blackout layer 200′ shown at a different installation location are illustrated in accordance with aspects of the present subject matter. Specifically, similar to the embodiment shown in FIGS. 10 and 11, the blackout layer 200′ is provided directly between the first wall segment 160 of the inner core 130 and the outer sock 120 such that the layer 200 extends across the second side 142 of the inner cellular structure 132 along the exterior of such structure 132. Additionally, the blackout layer 200 is configured to extend only partially across the second side 142 of the inner cellular structure 132. However, unlike the embodiment described above in which the blackout layer 200 extends from the first fold edge 150 of the inner core 130 across a portion of the first wall segment 160 to create a light-transmissible slot 250′ adjacent to the opposed end 154 of the first fold segment 160, the blackout layer 200 creates such a slot 250′ at a location adjacent to the first fold edge 150 of the inner core 130. Specifically, as shown in the illustrated embodiment, the blackout layer 200 extends along the outer surface of the first wall segment 160 from a first end 202′ positioned adjacent to the first end 154 of the inner core 130 to a second or “slot” end 204′ that is spaced apart from the first fold edge 150 of the inner core 130 such that the layer 200 defines a length 206′ that is shorter than the length 166 of the first wall segment 160. As a result, when the inner core 130 is positioned within the outer sock 120 and formed into the inner cellular structure 132, a light-transmissible slot 250′ may be defined between the slot end 204′ of the blackout layer 200 and the adjacent edge of the slat 100 (e.g., the front edge 106). For example, as shown in FIG. 12, the slot 250′ defined between the slot end 204′ of the blackout layer 200 and the front edge 106 of the slat 100 generally extends in the widthwise direction of the slat 100 across a given slot distance 252′. Similar to that described above, this slot distance 252′ may be selected based on a corresponding overlap distance 260′ (FIG. 15) of the slats 100 to provide different lighting effects depending on which direction the slats 100 are closed.

It should be appreciated that, although the “slotted” blackout configuration was only described above with reference to a blackout layer 200′ that was positioned between the inner core 130 and the outer sock 120 along the second side 142 of the inner cellular structure 132, the slotted blackout configuration may be provided at any other suitable location within the cellular slat 100 that provides a light-transmissible slot 250′ between the blackout layer 200 and an adjacent edge of the slat 100 through which light may be transmitted. For instance, similar to the embodiment shown in FIG. 5, a slotted blackout configuration may be provided on the inner surface 174 of the first wall segment 160 such that a slot 250′ is defined between the blackout layer 200 and either the front edge 106 or the rear edge 108 of the slat 100 along the second side 142 of the inner cellular structure 132. Alternatively, similar to the embodiments shown in FIGS. 6 and 7, a slotted blackout configuration may be provided along the first side 140 of the inner cellular structure 132 (e.g., along the inner surface 175 of the base wall segment 158 or between the base wall segment 158 and the outer sock 120) such that a slot 250′ is defined between the blackout layer 200 and either the front edge 106 or the rear edge 108 of the slat 100.

It should also be appreciated that the above-described blackout layer 200′ may be advantageously applied to cellular slats 100 including both an outer sock and an inner core or to sockless embodiments of the cellular slats 100. For instance, FIG. 17 illustrates a sockless embodiment of a cellular slat 100 similar to that shown in FIG. 16 incorporating an embodiment of the blackout layer 200′.

Referring now to FIGS. 14 and 15, partial, side views of the covering 20 described above with reference to FIG. 1 with the cellular slats 100 having the configuration shown in FIGS. 10 and 11 installed relative thereto and being tilted to respective closed positions are illustrated in accordance with aspects of the present subject matter. Specifically, FIG. 14 illustrates the slats 100 tilted to their first closed position (e.g., a closed-down position) such that the front edges 106 of the slats 100 face downwardly along the front side 48 of the covering 20 and the rear edges 108 of the slats 100 face upwardly along the rear side 50 of the covering 20. Additionally, FIG. 15 illustrates the slats 100 tilted to their second closed position (e.g., a closed-up position) such that the front edges 106 of the slats 100 face upwardly along the front side 48 of the covering 20 and the rear edges 108 of the slats 100 face downwardly along the rear side 50 of the covering 20. For purposes of illustration, each cellular slat 100 is shown schematically as a dashed oval 100, while the inner blackout layer 200′ of each cellular slat 100 is shown schematically as a solid line 200′. It should be appreciated that the description of FIGS. 14 and 15 generally applies regardless of whether the cellular slats 100 include both an outer sock and an inner core or are configured as sockless slats similar to that shown in FIG. 17.

In general, the one-sided, slotted blackout arrangement shown in FIGS. 14 and 15 provides similar lighting effects as those described above with reference to FIGS. 8 and 9 (i.e., for the one-sided, non-slotted blackout arrangement). For example, as shown in FIG. 14, with the slats 100 tilted to the closed-down position such that the blackout layer 200′ of each slat 100 is positioned along the rear side 50 of the covering 20, light 220 from the rear side 50 of the covering 20 is allowed to pass through each light-transmissible slot 250′ provided by the slotted blackout arrangement and into the interior of the slats 100, at which point the light is diffused across the interior of the cell 100 (as indicated by arrows 222). As a result of such light diffusion through each cell 100, the slats 100 will have a soft glow or soft lighting effect along the front side 48 of the covering 20 that provides a generally aesthetically pleasing look to the covering 20 and also serves to hide or render virtually unnoticeable any imperfections provided at the slat-to-interfaces. However, due the light-transmissible slots 250′ allowing more light to pass into the interior of each cell 100 than the non-slotted blackout arrangement described above with reference to FIG. 9, the increased amount of diffused light passing through each cell 100 illuminates the slats 100 to a greater degree. This can allow the texture of the fabric material used to form the outer socks 120 of the slats 100 to become more visible along the front side 48 of the covering 20, which can be desirable in many instances (e.g., when the outer socks 120 are formed from an aesthetically pleasing fabric). Moreover, the increased illumination of the slats 100 may also provide a greater contrast in the lighting effect provided between the closed-down and closed-up positions.

As shown in FIG. 15, with the slats 100 tilted to the closed-up position such that the blackout layers 200′ are positioned along the front side 48 of the covering 20, the slats 100 will provide a similar lighting effect as that described above with reference to FIG. 9. Specifically, the slats 100 will have a much darker appearance across the front side 48 of the covering 20. However, as shown in FIG. 15, to provide such a lighting effect with the slotted blackout arrangement, the blackout layers 200′ are configured to vertically overlap one another across the slots 250′, thereby allowing the blackout layers 200′ to generally block any light from passing through the slats 100 along the front side 48 of the covering 20. Such an overlapped configuration can be achieved by selecting the slot distance 252′ of each slat 100 to be less than an overlap distance 260′ across which adjacent slats 100 overlap at the slat-to-slat interfaces. In other words, the overlap distance 260′ may generally correspond to a maximum limit for the slat distance 252′ in order to achieve the desired lighting effect. Thus, the slot distance 252′ can generally be varied across a distance range from greater than zero to the overlap distance 260′, with smaller slot distances 252′ allowing less diffused light to pass through each cell 100 at the closed-down position (and, thus, a smaller contrast in the lighting effect between the closed-down and closed-up positions) and larger slot distances 252′ allowing more diffused light to pass through each cell 100 at the closed-down position (and, thus, a larger contrast in the lighting effect between the closed-down and closed-up positions).

Additionally, it should be appreciated that, due to the one-sided blackout arrangement, a small amount of diffuse light will be allowed to pass through the covering 20 at the slat-to-slat interfaces when the slats 100 are tilted to the closed-up position shown in FIG. 14. Similar to that described above with reference to FIG. 9, this small amount of diffuse light will provide a very soft, uniform reveal line (indicated by lines 240) at the slat-to-slat interface between each adjacent pair of slats that hides or renders virtually unnoticeable any imperfections defined at such interface.

It should also be appreciated that, in the sockless embodiments described herein (e.g., as shown in FIGS. 16 and 17), the slat core may be finished or covered along one or both of its sides for aesthetic purposes. For instance, in one embodiment, one side of the slat core may be painted or printed so as to provide an aesthetically pleasing look to the slat core. In another embodiment, a covering material (e.g., a fabric) may be laminated to one side of the slat core. Alternatively, such printing/painting or covering material may be applied to both sides of the slat core.

While the foregoing Detailed Description and drawings represent various embodiments, it will be understood that various additions, modifications, and substitutions may be made therein without departing from the spirit and scope of the present subject matter. Each example is provided by way of explanation without intent to limit the broad concepts of the present subject matter. In particular, it will be clear to those skilled in the art that principles of the present disclosure may be embodied in other forms, structures, arrangements, proportions, and with other elements, materials, and components, without departing from the spirit or essential characteristics thereof. For instance, features illustrated or described as part of one embodiment can be used with another embodiment to yield a still further embodiment. Thus, it is intended that the present subject matter covers such modifications and variations as come within the scope of the appended claims and their equivalents. One skilled in the art will appreciate that the disclosure may be used with many modifications of structure, arrangement, proportions, materials, and components and otherwise, used in the practice of the disclosure, which are particularly adapted to specific environments and operative requirements without departing from the principles of the present subject matter. For example, elements shown as integrally formed may be constructed of multiple parts or elements shown as multiple parts may be integrally formed, the operation of elements may be reversed or otherwise varied, the size or dimensions of the elements may be varied. The presently disclosed embodiments are therefore to be considered in all respects as illustrative and not restrictive, the scope of the present subject matter being indicated by the appended claims, and not limited to the foregoing description.

In the foregoing Detailed Description, it will be appreciated that the phrases “at least one”, “one or more”, and “and/or”, as used herein, are open-ended expressions that are both conjunctive and disjunctive in operation. The term “a” or “an” element, as used herein, refers to one or more of that element. As such, the terms “a” (or “an”), “one or more” and “at least one” can be used interchangeably herein. All directional references (e.g., proximal, distal, upper, lower, upward, downward, left, right, lateral, longitudinal, front, rear, top, bottom, above, below, vertical, horizontal, cross-wise, radial, axial, clockwise, counterclockwise, and/or the like) are only used for identification purposes to aid the reader's understanding of the present subject matter, and/or serve to distinguish regions of the associated elements from one another, and do not limit the associated element, particularly as to the position, orientation, or use of the present subject matter. Connection references (e.g., attached, coupled, connected, joined, secured, mounted and/or the like) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

All apparatuses and methods disclosed herein are examples of apparatuses and/or methods implemented in accordance with one or more principles of the present subject matter. These examples are not the only way to implement these principles but are merely examples. Thus, references to elements or structures or features in the drawings must be appreciated as references to examples of embodiments of the present subject matter, and should not be understood as limiting the disclosure to the specific elements, structures, or features illustrated. Other examples of manners of implementing the disclosed principles will occur to a person of ordinary skill in the art upon reading this disclosure.

This written description uses examples to disclose the present subject matter, including the best mode, and also to enable any person skilled in the art to practice the present subject matter, including making and using any devices or systems and performing any incorporated methods. The patentable scope of the present subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The following claims are hereby incorporated into this Detailed Description by this reference, with each claim standing on its own as a separate embodiment of the present disclosure. In the claims, the term “comprises/comprising” does not exclude the presence of other elements or steps. Furthermore, although individually listed, a plurality of means, elements or method steps may be implemented by, e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc., do not preclude a plurality. Reference signs in the claims are provided merely as a clarifying example and shall not be construed as limiting the scope of the claims in any way.

1. A cellular slat for a covering for an architectural structure, the cellular slat comprising:
a slat core forming a cellular structure having opposed first and second sides extending between opposed first and second edges of the slat core; and
a blackout layer provided in association with only one of the first side or the second side of the cellular structure of the slat core.

2. The cellular slat of claim 1, wherein the blackout layer extends across the only one of the first side of the second side of the cellular structure from the first edge to the second edge of the slat core.

3. The cellular slat of claim 1, wherein the blackout layer extends only partially across the one of the first side or the second side of the cellular structure such that a light-transmissible slot is defined between the blackout layer and one of a front edge or a rear edge of the cellular slat.

4. The cellular slat of claim 3, wherein the light-transmissible slot allows light to pass through the slat core and into an interior of the slat core along the only one of the first side or the second side of the cellular structure.

5. (canceled)

6. The cellular slat of claim 1, wherein the blackout layer is positioned on an exterior of the slat core or within an interior of the slat core along the only one of the first side or the second side of the cellular structure.

7. (canceled)

8. The cellular slat of claim 1, wherein:
the first and second edges of the slat core comprise first and second fold edges;
the slat core includes first and second ends, with the first and second fold edges being formed between the first and second ends such that the slat core includes a plurality of wall segments; and
the plurality of wall segments comprise a base wall segment extending between the first and second fold edges of the slat core, a first wall segment extending between the first fold edge of the slat core and the first end of the slat core, and a second wall segment extending between the second fold edge of the slat core and the second end of the slat core.

9. The cellular slat of claim 8, wherein the first and second wall segments at least partially overlap each other along the second side of the cellular structure, wherein the blackout layer is provided along the second side of the cellular structure.

10. (canceled)

11. (canceled)

12. (canceled)

13. (canceled)

14. (canceled)

15. (canceled)

16. (canceled)

17. The cellular slat of claim 1, further comprising an outer sock forming an outer cellular structure of the slat, the slat core being positioned within the outer sock.

18. (canceled)

19. A covering including a headrail, a bottom rail supported relative to the headrail, and a plurality of cellular slats positioned between the headrail and the bottom rail, wherein each cellular slat defines a front edge positioned along a front side of the covering and a rear edge positioned along a rear side of the covering, and wherein each cellular slat is configured in accordance with the cellular slat of claim 1.

20. The covering of claim 19, wherein:
the plurality of cellular slats are tiltable between a closed-down position and a closed-up position; and
the blackout layer is positioned along the front side of the covering when the plurality of cellular slats are tilted to one of the closed-down position or the closed-up position and the blackout layer is positioned along the rear side of the covering when the plurality of cellular slats are tilted to the other of the closed-down position or the closed-up position.

21. The covering of claim 20, wherein:
when the plurality of cellular slats are tilted to the closed-down position, an amount of light is allowed to pass from the rear side of the covering and into an interior of each of the plurality of cellular slats at slat-to-slat interfaces defined between adjacent cellular slats of the plurality of cellular slats such that the other of the only one of the first side or the second side of the cellular structure is partially illuminated along the front side of the covering; and
when the plurality of cellular slats are tilted to the closed-up position, the blackout layers of the plurality of cellular slats block light from passing through the only one of the first side or the second side of the cellular structure along the front side of the covering.

22. The covering of claim 19, wherein:
the plurality of cellular slats are tiltable between a closed-down position and a closed-up position; and
the plurality of cellular slats provide a different lighting effect depending on whether the plurality of cellular slats are positioned at the closed-down position or the closed-up position.

23. (canceled)

24. The covering of claim 19, wherein the blackout layer extends only partially across the one of the first side or the second side of the cellular structure such that a light-transmissible slot is defined between the blackout layer and one of the front edge or the rear edge of the cellular slat.

25. The covering of claim 24, wherein:
the light-transmissible slot defines a slot distance between the blackout layer and the one of the front edge or the rear edge of the cellular slat; and
the slot distance is less than an overlap distance defined between adjacent cellular slats of the plurality of cellular slats when the plurality of cellular slats are moved to a closed position.

26. The covering of claim 24, wherein the blackout layer of a first cellular slat of the plurality of cellular slats is configured to vertically overlap the blackout layer of a second cellular slat of the plurality of cellular slats when the plurality of cellular slats are moved to a closed position such that the overlapping backout layers extend vertically across the light-transmissible slot defined by either the first cellular slat or the second cellular slat.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. A covering for an architectural structure, the covering comprising:
a headrail;
a bottom rail supported relative to the headrail; and
a plurality of cellular slats positioned between the headrail and the bottom rail, each cellular slat defining a front edge positioned along a front side of the covering and a rear edge positioned along a rear side of the covering, and wherein each cellular slat comprises:
a slat core forming a cellular structure having opposed first and second sides extending between opposed first and second edges of the slat core; and
a blackout layer provided in association with only one of the first side or the second side of the cellular structure of the slat core;
wherein:
the blackout layer extends only partially across the one of the first side or the second side of the cellular structure such that a light-transmissible slot is defined between the blackout layer and one of the front edge or the rear edge of the cellular slat;
the light-transmissible slot defines a slot distance between the blackout layer and the one of the front edge or the read edge of the cellular slat; and
the slot distance is less than an overlap distance defined between adjacent cellular slats of the plurality of cellular slats when the plurality of cellular slats are moved to a closed position.

43. The covering of claim 42, wherein:
the closed position comprises at least one of a closed-down position or a closed-up position; and
the blackout layer is positioned along the front side of the covering when the plurality of cellular slats are tilted to one of the closed-down position or the closed-up position and the blackout layer is positioned along the rear side of the covering when the plurality of cellular slats are tilted to the other of the closed-down position or the closed-up position.

44. The covering of claim 43, wherein:
when the plurality of cellular slats are tilted to the closed-down position, an amount of light is allowed to pass from the rear side of the covering and into an interior of each of the plurality of cellular slats at slat-to-slat interfaces defined between adjacent cellular slats of the plurality of cellular slats such that the other of the only one of the first side or the second side of the cellular structure is partially illuminated along the front side of the covering; and
when the plurality of cellular slats are tilted to the closed-up position, the blackout layers of the plurality of cellular slats block light from passing through the only one of the first side or the second side of the cellular structure along the front side of the covering.

45. The covering of claim 42, wherein:
the closed position includes at least one of a closed-down position or a closed-up position; and
the plurality of cellular slats provide a different lighting effect depending on whether the plurality of cellular slats are positioned at the closed-down position or the closed-up position.

46. The covering of claim 42, wherein the blackout layer of a first cellular slat of the plurality of cellular slats is configured to vertically overlap the blackout layer of a second cellular slat of the plurality of cellular slats when the plurality of cellular slats are moved to a closed position such that the overlapping backout layers extend vertically across the light-transmissible gap defined by either the first cellular slat or the second cellular slat.

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)
